(19) United States
(12) Patent Application Publication
(10) Pub. No.: US 2025/0258062 A1
(43) Pub. Date: Aug. 14, 2025

(54) METHOD FOR MONITORING A TURBOMACHINE

(71) Applicant: MTU Aero Engines AG, München (DE)

(72) Inventor: Georg Schoenberger, Günding (DE)

(73) Assignee: MTU Aero Engines AG, München (DE)

(21) Appl. No.: 19/040,390

(22) Filed: Jan. 29, 2025

(30) Foreign Application Priority Data
Feb. 8, 2024 (DE) 10 2024 103 612.5

(51) Int. Cl. G01M 15/14; G01H 13/00

(52) U.S. Cl. CPC G01M 15/14; G01H 13/00

(57) ABSTRACT

The present invention relates to a method for monitoring a turbomachine, in particular of an aircraft engine, wherein the turbomachine is equipped with a microphone array, wherein the microphone array has at least two microphones, which, in relation to the longitudinal axis of the turbomachine, are arranged at different axial positions and/or circumferential positions, in which during an operation of the turbomachine, sounds emitted by the turbomachine are captured with the microphone array.

### BACKGROUND OF THE INVENTION

The present invention relates to a method for monitoring a turbomachine, in particular an aircraft engine.

The inspection of turbomachines, in particular aircraft engines, can take on a special importance on 3 account of any ensuing faults, for example, in the event of failure. For this reason, aircraft engines, for example, are subjected to routine inspection or maintenance, which can comprise, for example, a visual examination for sites of damage, in particular those of components arranged in the gas channel. For example, such damage site(s) can ensue from particle impacts or wear and tear during flight operation, although these account for only some of the possible fault conditions. In general, in such maintenance, a challenge is posed in that the maintenance occurs only at certain intervals, that is, only after a specific period of operation. In the case of fault conditions that arise early on in the maintenance interval or rapidly worsen, for example, a timely detection is at least make difficult.

### SUMMARY OF THE INVENTION

The present invention is based on the technical problem of specifying an advantageous method for monitoring a turbomachine, in particular an aircraft engine.

This problem is solved by the method of the present invention. For this purpose, the turbomachine will be, or is equipped with, a microphone array, which has at least two microphones. These microphones are arranged at different axial positions and/or circumferential positions in relation to a longitudinal axis of the turbomachine; that is, it is possible in graphic terms to use the microphone array to “listen to” the turbomachine along it and/or circumferentially to it. In general, it is possible to use the acoustic detection to implement a monitoring during operation. The microphone array can thereby provide a spatial resolution, that is, it will permit a certain localization of any anomalies that may occur, for example.

During operation of the turbomachine, sounds emitted by the turbomachine are captured with the microphone array (step i) and subsequently analyzed, thereby allowing, for example, a conclusion to be drawn about any abnormalities. As discussed in detail below, the analysis can occur preferably in an AI-based manner (step ii), whereby, by use of this combination of acoustic detection and AI-based analysis, it is then also possible, for example, to monitor the turbomachine in situ when it is used during flight operation, for example. Anomalies or fault conditions that occur can thus be determined sometimes instantaneously or, in any case, after a short period of time in comparison to the maintenance intervals. By way of example, such a fault condition may involve an imbalance or low-or high-frequency gas vibrations (buzz and screech) or a jet pipe resonance (refer to the following detailed description).

Further preferred embodiments are found in the dependent claims and in the disclosure in full, whereby a distinction is not always made in detail between method aspects or use aspects and device aspects; in any case, the disclosure is to be read implicitly in regard to all claim categories. If, for example, the method is discussed with reference to a turbomachine having a specifically designed microphone array, this is to be read at the same time as a disclosure of a turbomachine that is equipped with such a microphone array.

The sounds measured by use of the individual microphones can be merged in an electronic analysis unit. In it, a processing of the measurement data, such as, for example, a decomposition into frequency components, and, optionally, the AI-based analysis can also occur. However, the analysis unit or analysis can also be located or performed elsewhere, integrated into a computer-processing unit of the aircraft or airplane (for example, an on-board computer), for instance, or, in general, even externally. Regardless of the detailed implementation, subjects of this analysis can be, for example, the propagation times of the sound waves; alternatively or additionally, it is also possible to examine the frequency spectrum.

The specifications “axially,” “radially,” and “circumferentially (peripherally) as well as the associated directions and positions (axial positions, circumferential (peripheral) positions, etc.) are relative to a longitudinal axis of the turbomachine. During operation, for example, the rotors of the turbomachine can rotate around this longitudinal axis; that is, the longitudinal axis can coincide with their rotational axis. Furthermore, during operation, compressor gas or hot gas can flow through the turbomachine along the longitudinal axis in an annular or sleeve-shaped gas channel, for instance, that is arranged around the longitudinal axis.

Regarded functionally, the turbomachine can be divided into a compressor, a combustion chamber, and a turbine. In the compressor, a compressor fluid, such as, for example, air intake, is compressed and, in the downstream combustion chamber, fuel (for example, kerosene) is admixed with it and this mixture undergoes combustion. In the downstream turbine, the hot gas that is formed undergoes expansion, whereby, for example, energy is withdrawn, also proportionately, for driving the rotors.

In accordance with a preferred embodiment, the microphone array has a respective microphone at least at 3 different axial positions, preferably at least at 5, 10, 15, or 20 different axial positions. Possible upper limits, which, for example, can also depend on the size of the engine, lie at, for example, at most 500, 400, 300, 200, 100, or 50 axial positions. The axial positions can lie within an individual module (compressor, combustion chamber, or turbine); preferably, they extend over at least two modules or all three modules. This can expand the number of fault conditions that can be monitored, for example.

In a preferred embodiment, the microphone array has microphones at least at two different circumferential positions. In graphic terms, it is thereby possible to “listen to” the engine from different sides; preferably, the microphones are distributed at least at three circumferential positions (possible upper limits can lie, for example, at 50, 20, 10, or 6 circumferential positions).

In accordance with a preferred embodiment, at least at five different respective axial positions, the microphone array has respectively at least three microphones, which are arranged at the respective axial position with different circumferential positions. In other words, there are microphones at least at five axial positions, each with at least three circumferential positions (that is, the microphone array comprises at least 15microphones). In regard to further possible lower and upper limits for the number of axial and circumferential positions, reference is made to the preceding paragraphs. In general, in this case, the microphones can also be skewed with respect to one another from one axial position to another in a helical shape, for example. Preferably, they are each arranged at the same circumferential position from one axial position to another; that is, apart from any radial displacement, they are in alignment.

In accordance with a preferred embodiment, the axial positions are distributed equidistantly and/or the circumferential positions are distributed equiangularly; that is, there exist equally large angles between adjacent circumferential positions. In the case of three circumferential positions, these positions can each be skewed, for example, by 120° with respect to one another (in the case of four circumferential positions, by 90°, etc.).

In a preferred embodiment, step i) occurs, at least proportionately, during flight operation, that is, during air flight. Alternatively or additionally, step i) can occur, at least proportionately, during the startup of the aircraft engine and/or during the shutdown of the aircraft engine following flight operation. This can have advantages, for example, because of the reduced background noise in comparison to flight operation (less ambient and interfering sounds). In such a way, a detection during flight operation and a detection before/after flight operation can thus supplement each other.

In accordance with a preferred embodiment, the sounds detected with the microphone array undergo an artificial intelligence (AI) based analysis, that is, by using an AI algorithm.

In a preferred embodiment, the sounds of the turbomachine captured with the microphone array can be decomposed to their component frequencies and at least these frequency components then will undergo AI-based analysis. This can occur, for example, by way of a Fourier transformation, such as, for example, by way of FFT (fast Fourier transformation). Regardless of the detailed implementation, the frequency analysis can be combined with an analysis of the propagation times and/or amplitudes or else provided as an alternative.

In a preferred embodiment, the AI-based analysis of the captured sounds occurs in an analysis unit, which is integrated in or on the aircraft, in particular the airplane. In this way, the analysis unit can be integrated with the microphone array on the engine or else be provided at another site of the aircraft, such as, for example, also as a part of the on-board computer.

In that step ii) is performed in the aircraft itself, the result or the status can exist close in time to the monitoring and, for example, can be independent of a data or communication link. When a fault condition is determined, the analysis unit can initiate, for example, automated measures (for example, via an electric controller), such as, for instance, immediate measures for protecting the aircraft engine and/or the aircraft or airplane. Alternatively or additionally, a status can be displayed in the cockpit in connection with, for instance, recommended actions for implementation on the part of the pilot.

In accordance with a preferred embodiment, the AI-based analysis in accordance with step ii) occurs for at least one of the following fault conditions:
jet pipe resonance and/or low-and high-frequency gas vibrations (buzz and screech) (as a result of which, for example, there is faster diagnosis and faster intervention in the control and hence the avoidance of critical work areas, particularly in the case of military aircraft engines);
imbalance (for example, fine-or high-granularity localization of the cause, for instance over the stages or modules, making higher resolution possible in comparison to mechanical vibration measurements);
engine pumps (as a result of which, there is a rapid detection and, in the event of a corresponding control, the avoidance of dangerous work points, in particular in the case of military aircraft engines);
anomaly in the ignition behavior of the combustion chamber and/or afterburner (wear-free monitoring);
anomaly of auxiliary components, that is, of the supply system, such as, for example, of lines, valves, etc. (detection of leakages or faulty behavior of actuators, for example);
damage to bearings (early detection of an incipient damage to bearings, for example, can prevent or avoid secondary damages entailing further deterioration);
asymmetric combustion (detection of anomalies in the combustion chambers);
penetration of foreign bodies (for example, tracing the place of origin of the foreign body, internally or externally, by way of the signal propagation times, as well as mass determination, for example);
blade or vane defects or a structural change in guide vane airfoils and blade airfoils of the individual engine stages (the fan, the compressor, or turbine units).

In accordance with a preferred embodiment, the sounds recorded during operation of the turbomachine and/or the incorporation of the theoretical operating state additionally cross-checked with further measurement results obtained during operation, such as, for example, with measurement data of one sensor or a plurality of sensors, such as, for example, a rotational speed sensor or rotational speed sensors and/or a temperature sensor or temperature sensors.

The application also relates to a method for training an AI; that is, it relates to an AI algorithm. The training data are hereby determined on a turbomachine that is equipped with a microphone array having axially and/or circumferentially distributed microphones (refer to the preceding description for details). Preferably, the turbomachine is mounted on a test stand, that is, is stationary in a test environment, for the determination of the training data.

The training data can then be used, for example, to train a so-called unsupervised learning algorithm, with which the data can be investigated for patterns without the necessity of having known target values beforehand. In this way, it is possible, for example, to differentiate abnormalities from a common variance. That is, the data can be sorted according to “feature” clusters and hence according to commonalities. Alternatively or additionally, a so-called supervised learning algorithm, which, for example, can be learned and/or monitored, can find application.

It is possible in this way to establish a correlation between fault conditions identified on the basis of human-determined empirical values or other kinds of investigations and the recorded sounds. The acoustic data recorded on an engine or the turbomachine with a specific fault condition can be correspondingly marked for this purpose, said marking also be referred to as “labeling”. For this purpose, it is possible to create a cross-checking or a linkage of the measurement results from the maintenance and inspection area (this can result in labels, such as, for example, “defective bearing,” “imbalanced vane or blade airfoils,” “jet pipe resonance,” etc.).

In a preferred embodiment, the algorithm trained on the basis of training data recorded on the test stand is then further trained on the basis of data recorded in the field, in particular during flight operation (preferably on engines of identical construction).

For example, it is possible in a specific manner to produce fault conditions at certain engine positions. This generates a sound signature that deviates from that of normal operation. On the basis of the differences in propagation times and the known position of the fault, this input data can be used in order to train an AI system to the extent that a position of a fault can be localized within an engine or a turbomachine.

In a further preferred embodiment, a plurality of engines in an engine fleet can be monitored acoustically in a continuous manner by using an above-described microphone array and the data can be recorded. In the case of routinely provided engine maintenance (so-called shop visits), it is possible to determine the actual state of the engine and to compare it with the data acquired with the microphone array. In this way, the changes in the engine detected during the maintenance can be assigned to the acoustic data. With the assistance of this correlated acoustic data, it is possible (by using hardware of the engine during inspection) to train an AI software. In a further development, it is possible for an actual state determined in a shop visit to calculate theoretical efficiency or performance data by using methods known from the prior art. These calculated performance data can be correlated with the acoustic signature recorded by the microphone array prior to the shop visit in order to train an AI software to estimate/predict a performance state, in particular a loss of efficiency, on the basis of the acoustic signature.

This AI, as a component of the engine health monitoring of the engine in flight, can alert the pilots when a critical incident has taken place or afford a conclusion as to whether the engine needs to undergo unscheduled inspection or maintenance.

The application further relates to a turbomachine, in particular an aircraft engine that is designed for a method as disclosed above. To this end, the turbomachine is equipped with a microphone array that has a plurality of axially and/or circumferentially distributed microphones (refer to the rest of the disclosure in regard to possible further details).

The application further relates to the use of such a turbomachine in a method as presently disclosed.

### BRIEF DESCRIPTION OF THE DRAWING FIGURES

The invention will be described in detail below on the basis of exemplary embodiments, whereby the individual features can also be of essence to the invention in other combinations.

Shown specifically are

FIG. 1 is a turbomachine, namely, an aircraft engine, with a microphone array in a schematic side view;

FIG. 2 is a schematic axial view of a turbomachine in accordance with FIG. 1;

FIG. 3 shows several method steps in a flow chart.

### DESCRIPTION OF THE INVENTION

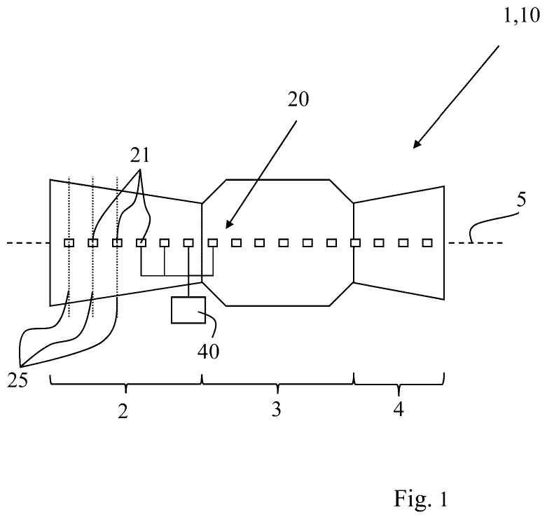

FIG. 1 shows a turbomachine 1, which, in the present example, is an aircraft engine 10. It is divided functionally into a compressor 2, a combustion chamber 3, and a turbine 4, with air intake being compressed in the compressor 2 during operation. In the combustion chamber 3, fuel, such as, for example, kerosene, is admixed and this mixture undergoes combustion, whereby the hot gas formed undergoes expansion in the downstream turbine 4. Typically, the hot gas thereby drives rotors (not depicted) of the turbine 4, which are arranged in a plurality of stages, whereby kinetic energy is also used to drive the compressor 2.

During operation, the rotors rotate around a longitudinal axis 5, whereby this rotational movement can result in an imbalance on account of wear and tear or improper fit, for example. This is intended to illustrate only one conceivable fault condition. In regard to further conceivable fault conditions, reference is made to the preceding description. For the monitoring of one such fault condition or a plurality of fault conditions, the turbomachine 1 is equipped with a microphone array 20, which has a plurality of microphones 21. As can be seen from FIG. 1, these are arranged in axial distribution along the turbomachine 1, that is, at different axial positions 25. In the present example, they are distributed equidistantly along the longitudinal axis 5, namely, over the compressor 2, the combustion chamber 3, and the turbine 4.

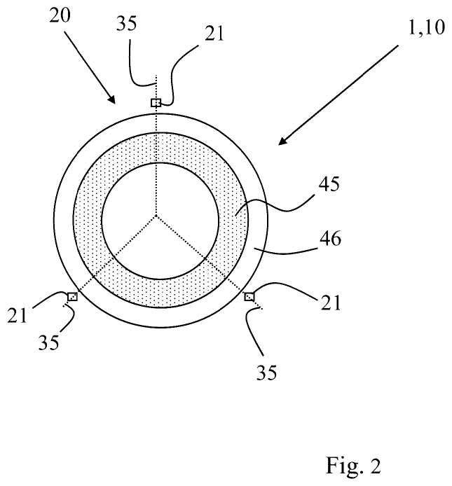

As can be seen from the axial view in accordance with FIG. 2, the microphones 21 of the microphone array 20 are further distributed also circumferentially, that is, at different circumferential positions 35 around the longitudinal axis 5. In the axial view, a microphone 21 can be seen for each circumferential position 35 and, perpendicular to the plane of the draining, for each circumferential position 35, a respective multiplicity of microphones are arranged axially in succession analogously to the depiction in accordance with FIG. 1.

A respective microphone 21 can be used in each case during operation of the turbomachine 1 to capture emitted sounds, namely, at its respective axial and circumferential positions 25, 35. These measurement data are merged in an analysis unit 40, referenced only schematically in FIG. 1. In general, this can occur in a wireless manner or a wired manner (in FIG. 1, for purposes of clarity, only a wiring of four microphones 21 is shown). Following this merging of the data and, if need be, data processing, the sounds captured with the microphone array 20 undergo AI-based analysis, that is, by using a correspondingly trained AI algorithm.

Accordingly, anomalies or abnormalities of the recorded sounds can be assigned to mechanical anomalies during operation of the turbomachine 1, such as, for example, an imbalance (or other fault conditions). On account of the axially and circumferentially distributed microphones 21, a certain spatial resolution, that is, a fault localization with a certain granularity is thereby obtained.

As can be seen from the side view in accordance with FIG. 1 and also from the axial view in accordance with FIG. 2, the microphone or microphones 21 are arranged radially outside of the so-called engine body. That is, they rest in place radially outside of the gas channel 45 on or at, for example, the structural elements 46 (for example, gas channel plates, etc.) that bound the gas channel 45. In the radially outward direction, the turbomachine 1 and the microphone array 20 can then be enclosed by a separate housing structure, as is the case, for instance, in the civil aviation sector. Alternatively, they can also be integrated directly in the aircraft or airplane.

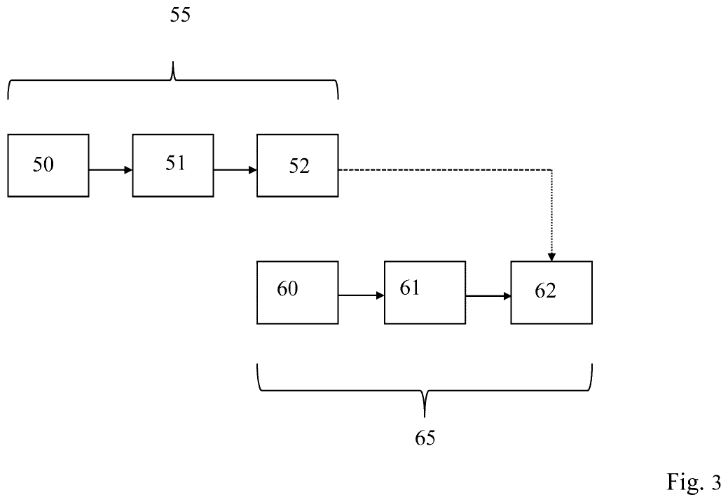

FIG. 3 summarizes some of the method steps in a flow chart. As explained above, the microphone array and the AI-based analysis for the monitoring 65 of a turbomachine are employed in application in an aircraft engine in flight operation, for example. Beforehand, for a corresponding training 55 of an AI algorithm, a turbomachine on a test stand is equipped with a microphone array 50. During operation on the test stand, the sounds emitted by the turbomachine are captured 51. Subsequently, these measurement data are cross-checked, that is, correlated, with the fault conditions 52.

For the monitoring 65 of a turbomachine of an identically constructed aircraft engine, for example, it is then likewise equipped with a microphone array 60. This microphone array is set up and arranged in analogy to that of the turbomachine on the test stand. Accordingly, sounds emitted during operation of the turbomachine are captured and subsequently undergo AI-based analysis 62. The latter step can comprise an analysis of propagation times and/or of the frequency spectrum as described herein.

1. A method for monitoring a turbomachine,
wherein the turbomachine is equipped with a microphone array,
wherein the microphone array has at least two microphones, which, in relation to a longitudinal axis of the turbomachine, are arranged at different axial positions and/or circumferential positions,
i) wherein, during an operation of the turbomachine, capturing sounds emitted by the turbomachine with the microphone array.

2. The method according to claim 1, wherein the microphone array has microphones at least at three different axial positions and/or microphones at least at two different circumferential positions.

3. The method according to claim 1, wherein the microphone array has at least five different axial positions, each having at least three microphones, which are arranged at different circumferential positions.

4. The method according to claim 1, wherein the different axial positions are distributed equidistantly and/or the different circumferential positions are distributed equiangularly.

5. The method according to claim 1, wherein the turbomachine is an aircraft engine, which is installed on or in an aircraft, with step i) occurring, proportionately, during a flight operation.

6. The method according to claim 1, wherein the turbomachine is an aircraft engine, which is installed on or in an aircraft, with step i) occurring, proportionately, during a startup of the aircraft engine prior to a flight operation and/or during a shutdown after a flight operation.

7. The method according to claim 1, further comprising the step of:
ii) the sounds captured with the microphone array undergoing an AI-based analysis.

8. The method according to claim 7, wherein the sounds captured with the microphone array are decomposed into frequency components and, in step ii), the frequency components undergo an AI-based analysis.

9. The method according to claim 7, wherein the AI-based analysis occurs in accordance with step ii) in an analysis unit of an aircraft.

10. The method according to claim 7, wherein the turbomachine is an aircraft engine, which is installed on or in an aircraft, wherein, in the course of the AI-based analysis in accordance with step ii), a check for at least one of the following fault conditions occurs: jet pipe resonance, low-frequency gas vibrations, high-frequency gas vibrations, imbalance, engine pumps, anomaly in the ignition behavior of the combustion chamber, anomaly in the ignition behavior of the afterburner, anomaly of auxiliary components, damage to bearings, asymmetric combustion of the combustion chamber, penetration of foreign particles.

11. The method according to claim 7, wherein, in the AI-based analysis in step ii), measurement data additionally determined with another sensor on the turbomachine are taken into consideration.

12. A method for training AI for an application in a method according to claim 7, wherein
a turbomachine on a test stand is equipped with a microphone array; wherein the microphone array has at least two microphones, which, in relation to a longitudinal axis of the turbomachine, are arranged at different axial positions and/or circumferential positions,
wherein
i) during an operation of the turbomachine on the test stand, sounds emitted by the turbomachine are captured with the microphone array of the turbomachine,
ii) the sounds captured with the microphone array are cross-checked with fault conditions that are observed on the turbomachine.

13. The method according to claim 12, wherein the data determined on the turbomachine on the test stand is supplemented by data from the field.

14. A turbomachine configured and arranged for carrying out the method and being used according to the method of claim 1, the turbomachine being equipped with a microphone array, which has at least two microphones, which, in relation to a longitudinal axis of the turbomachine, are arranged at different axial positions and/or circumferential positions.

15. (canceled)
